(19) United States
(12) Patent Application Publication
(10) Pub. No.: US 2016/0064983 A1
(43) Pub. Date: Mar. 3, 2016

(54) CHARGING APPARATUS CONNECTABLE TO TELEPHONE

(71) Applicants: Jian Xie, Rizhao (CN); Xuezhong Li, Rizhao (CN); Fandong Bu, Rizhao (CN); Zhengxi Wu, Rizhao (CN); Yanzhuo Wang, Rizhao (CN)

(72) Inventors: Jian Xie, Rizhao (CN); Xuezhong Li, Rizhao (CN); Fandong Bu, Rizhao (CN); Zhengxi Wu, Rizhao (CN); Yanzhuo Wang, Rizhao (CN)

(73) Assignee: SHANDONG BITTEL ELECTRONICS CO., LTD, Rizhao (CN)

(21) Appl. No.: 14/397,546

(22) PCT Filed: May 21, 2013
(86) PCT No.: PCT/CN2013/075951

§ 371 Date: Oct. 28, 2014

(30) Foreign Application Priority Data
Apr. 24, 2013 (CN) 201310145280.0

(51) Int. Cl. H02J 7/00; H01R 24/60; H01R 27/02

(52) U.S. Cl. CPC H02J 7/0055; H01R 27/02; H01R 24/60; H02J 7/0044; H02J 2007/0062; H02J 2007/0059

(57) ABSTRACT

A charging apparatus connectable to a telephone includes: a base (101), a supply voltage stabilizing device (102), a line coupler device (103) and a charging port (104, 105). The supply voltage stabilizing device and the line coupler device are both fixedly installed on the base; an input port of the supply voltage stabilizing circuit is connected to a supply power (110), the supply voltage stabilizing device is respectively connected to the input port of the line coupler device and the charging port through different output ports; another input port of the line coupler device is connected to a telephone line (120), an output port of the line coupler device is connected to a fixed telephone (130); the charging port comprises a USB port (104) and a charging cable (105); an electrical device is connected to the charging apparatus through a corresponding charging port. Functions for powering a fixed telephone and charging for several electrical products at the same time are integrated in the charging apparatus. Thus, the charging mode of the electrical device become more convenience and quick, an occupation for a commercial power socket and the usage for various special charging apparatuses are greatly reduced.

The present application claims priority to Chinese Patent Application No. 201310145280.0, entitled “CHARGING APPARATUS CONNECTABLE TO TELEPHONE”, filed on Apr. 24, 2013 with the State Intellectual Property Office of People's Republic of China, which is incorporated herein by reference in its entirety.

### FIELD OF TECHNOLOGY

The present disclosure relates to the technical field of communication, and in particular to a charging apparatus connectable to a telephone.

### BACKGROUND

With a rapid development of communication industry, electrical products, such as a mobile phone and a tablet computer, have become every day carry items for people. Because different electrical products accessorize different charging apparatuses, lots of charging apparatuses are inconvenient for the usage, storage and carrying. If the charging apparatus is forgotten in the travel, a corresponding electrical device can not be used when the battery runs out.

### SUMMARY

In view of this, a charging apparatus connectable to a telephone is provided, so as to provide a convenience and quick charge mode, and solve a problem of inconvenience for the usage, storage and carrying, which is caused by excessive special charging apparatuses.

To implement the purpose, the technical solution of the disclosure is provided as follows.

A charging apparatus connectable to a telephone includes: a base, a supply voltage stabilizing device, a line coupler device and a charging port; wherein

the supply voltage stabilizing device and the line coupler device are both fixedly installed on the base; an input port of the supply voltage stabilizing circuit is connected to a supply power, a first output port of the supply voltage stabilizing device is connected to a first input port of the line coupler device, a second output port of the supply voltage stabilizing device is connected to the charging port; a second input port of the line coupler device is connected to a telephone line; an output port of the line coupler device is connected to a telephone; the charging port includes a USB port and a charging cable; an electrical device is connected to the charging apparatus through a corresponding charging port.

Preferably, the electrical device is connected to the USB port through a converter cable adapting to a charging port of the electrical device and the USB port; and the USB port includes an A type USB female port.

Preferably, at least a Mini USB port, a Micro USB port, an Apple lighting port and an Apple Docking port are provided on the charging cable to directly connect with different electrical devices.

Preferably, the base is connected to the telephone through a buckle and a slot, or through a screw.

Preferably, the power supply includes a direct current outputted by an alternating current to direct current power adapter and/or a direct current outputted by active Ethernet PoE.

It may be seen from above technical solution, on one hand, the supply voltage stabilizing device may transform a voltage provided by an external power supply into an operating voltage of the telephone, and output the operating voltage of the telephone via a first output port of the supply voltage stabilizing device. The line coupler device may couple the first output port and a telephone line, and the operating voltage of the telephone may be output to the telephone via the output port of the line coupler device. On the other hand, the supply voltage stabilizing device may transform the voltage provided by an external power supply into respective charging voltages for various electrical devices, and output the charging voltages to charging ports via a second output port of the supply voltage stabilizing device. In this way, the electrical device connected to the charging port may be charged. Functions for powering the telephone and charging for several electrical products at the same time are integrated in the charging apparatus according to the disclosure. Thus, the charging mode of the electrical device become more convenience and quick; an occupation for a commercial power socket and the usages for various special charging apparatuses are greatly reduced; and a problem of inconvenience for the usage, storage and carrying, which is caused by excessive special charging apparatuses, are solved.

### BRIEF DESCRIPTION OF THE DRAWINGS

To describe the technical solutions for the embodiment of the present disclosure or conventional technology more clearly, the following briefly describes the drawings involved in the embodiments of the present disclosure or in the conventional technology. Apparently, the drawings described below are some embodiments, and persons of ordinary skill in the art can derive other drawings according to the drawings without any creative effort.

FIG. 1 is a structural schematic diagram of a charging apparatus connectable to a telephone according to an first embodiment of the disclosure;

FIG. 2 is a structural schematic diagram of a charging apparatus connectable to a telephone according to a second embodiment of the disclosure.

### DETAILED DESCRIPTION OF THE EMBODIMENTS

To describe the technical solutions for the embodiment of the present disclosure completely and clearly, the following describes the drawings involved in the embodiments of the present disclosure. Apparently, the described embodiments are merely a few rather than all of the embodiments of the present disclosure. All other embodiments obtained by persons of ordinary skill in the art are based on the embodiment of the present disclosure without creative efforts shall fall within the protection scope of the present disclosure.

An embodiment of the present disclosure discloses a charging apparatus connectable to a telephone, to provide a convenience and quick charging mode and solve an problem of inconvenience for the usage, storage and carrying, which is caused by excessive special charging apparatuses

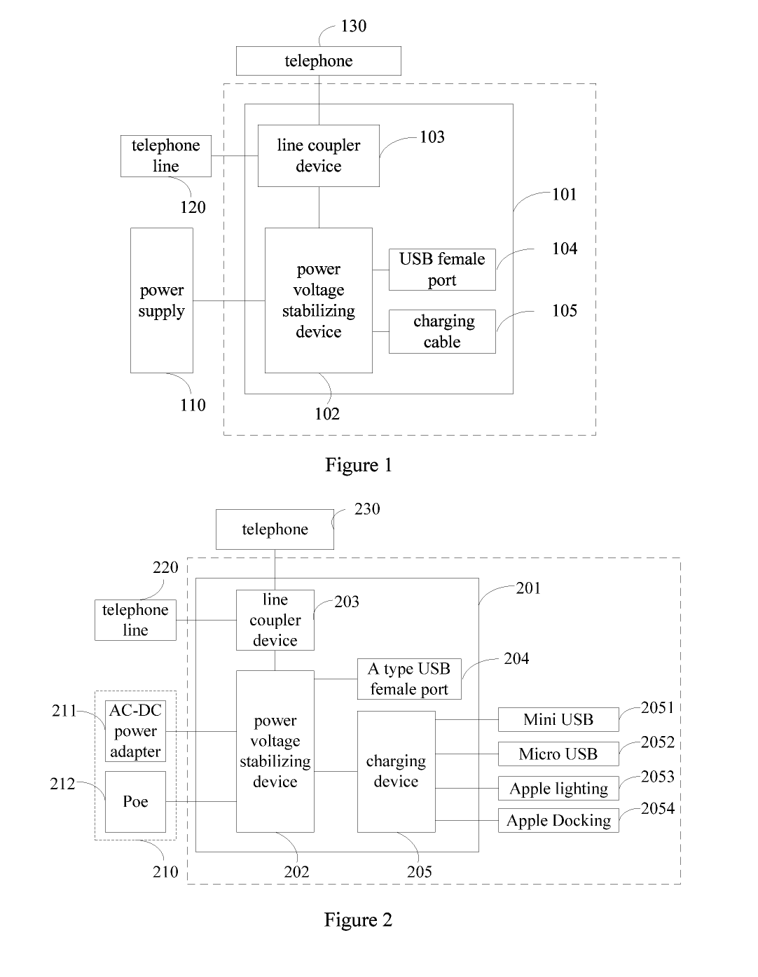

With reference to FIG. 1, a charging apparatus connectable to a telephone according to a first embodiment of the disclosure includes: a base 101, a supply voltage stabilizing device 102, a line coupler device 103 and a charging port. The charging port includes a USB port 104 and a charging cable 105. The supply voltage stabilizing device 102 and the line coupler device 103 are both fixedly installed on the base 101; an input port of the supply voltage stabilizing circuit 102 is connected to a power supply 110, a first output port of the supply voltage stabilizing device 102 is connected to a first input port of the line coupler device 103, a second output port of the supply voltage stabilizing device 102 is connected to the USB port 104 and the charging cable 105; a second input port of the line coupler device 103 is connected to a telephone line 120, an output port of the line coupler device 103 is connected to a telephone 130. Several electrical devices may be connected to corresponding charging ports of the charging apparatus to charge at the same time.

Based on the above structure, in the first embodiment of the disclosure, on one hand, the supply voltage stabilizing device may transform a voltage provided by an external power supply into an operating voltage of a telephone, and output the operating voltage of the telephone via a first output port of the supply voltage stabilizing device. The line coupler device may couple the first output port and a telephone line, and the operating voltage of the telephone may be output to the telephone via the output port of the line coupler device. On the other hand, the supply voltage stabilizing device may transform the voltage provided by an external power supply into respective charging voltages for various electrical devices, and output the charging voltages to charging ports via a second output port of the supply voltage stabilizing device. In this way, the electrical device connected to the charging ports may be charged. Functions for powering the telephone and charging for several electrical products at the same time are integrated in the charging apparatus according to the disclosure. Thus, the charging mode of the electrical device become more convenience and quick; an occupation for a commercial power socket and the usage for various special charging apparatuses are greatly reduced; and a problem for inconvenience of the usage, storage and carrying, which is caused by excessive special charging apparatuses, are solved.

The charging apparatus according to the disclosure may be applied to a family. When an electrical device needs to be charged, it is need to connect the electrical device and the charging apparatus according to the disclosure via the corresponding port to charge the electrical device, rather than temporarily finding a special charging apparatus for the electrical device. The charging apparatus according to the disclosure may also be applied to a place with a large turnover, such as a hotel. In the disclosure, the charging apparatus is connected to a telephone, so as to facilitate the management for related person, reduce the purchases for various special charging apparatus. With charging apparatus according to the disclosure, a traveler in the hotel may charge the electrical device thereof anytime through the charging apparatus, instead of his own special charging apparatus, which facilitates travelers and improves a service quality and a favorability of the hotel.

Referring to FIG. 2, a charging apparatus connectable to a telephone is provided according to a second embodiment of the disclosure. The charging apparatus includes a base 201, a supply voltage stabilizing device 202, a line coupler device 203, a USB port 204 and a charging cable 205.

The base 201 may be connected to a telephone 230 through a buckle and a slot, or through a screw, to fix the charging apparatus below the telephone 230. In this way, the charging apparatus may be integrated with the telephone, to ensure a relative stability between the charging apparatus and the telephone. That is, a charging function is added to the telephone, space is fully utilized, and an occupying area of the charging apparatus is reduced.

An input port of the supply voltage stabilizing circuit 202 is connected to power supply 210, a first output port of the supply voltage stabilizing device 202 is connected to a first input port of the line coupler device 203, a second output port of the supply voltage stabilizing device 202 is connected to the USB port 204 and the charging cable 205; a second input port of the line coupler device 203 is connected to a telephone line 220, an output port of the line coupler device 203 is connected to a telephone 230.

Specifically, a USB port 204 is an A type USB female port; kinds of ports for common electrical devices such as Mini USB port 2051, Micro USB port 2052, Apple lighting port 2053 and Apple Docking port 2054 are provided on the charging cable 205. For an electrical device which is charged through a USB port in an original charging way, a charging port of the electrical device is connected to the USB port 204 via a converter cable needed in the original charging way, to charge this kind of electrical device. In the case that the converter cable is not provided or not convenient for use, the electrical device may be directly connected to a corresponding port of charging cable 205 to charge this kind of electrical device. Several electrical devices may be connected to the charging apparatus through respective charging ports to charge at the same time.

In addition, in the charging apparatus according to the all embodiments of the disclosure, an external power supply thereof can either be a direct current outputted by an alternating current to direct current (AC-DC) power adapter, or a direct current outputted by active Ethernet (PoE) 212.

Based on the above structure, charging ports according to the embodiments of the disclosure includes: various ports for common electrical device such as smart phone, audio and video player, and tablet computer. In this way, kinds of electrical devices may be charged at the same time, and spaces occupied by kinds of special charging apparatus are greatly saved.

It may be understood for persons of ordinary skill in the art that, a part or all of procedure for the above methods of embodiments may be accomplished through instructing related hardware by a computer program, which may be stored in a computer readable memory medium. The computer program may include the procedure for the above methods of embodiments when executing, where the memory medium may be a disk, a CD (compact disc), a ROM (Read-Only Memory, ROM) or a RAM (Random Access Memory).

Persons of skill in the art can realize or use the device in the disclosure according to above specification of the disclosed embodiments. Numerous modifications for the embodiments is obvious to persons of skill in the art, general principle defined in the disclosure may be realized without departing from the spirit and scope of the disclosure. Hence, the disclosure is not limited to the embodiments in the disclosure, but confirms to widest scope which is consistent with principle and novel features disclosed by the disclosure.

1. A charging apparatus connectable to a telephone, comprising: a base, a supply voltage stabilizing device, a line coupler device and a charging port; wherein
the supply voltage stabilizing device and the line coupler device are both fixedly installed on the base; an input port of the supply voltage stabilizing circuit is connected to a supply power, a first output port of the supply voltage stabilizing device is connected to a first input port of the line coupler device, a second output port of the supply voltage stabilizing device is connected to the charging port; a second input port of the line coupler device is connected to a telephone line; an output port of the line coupler device is connected to the telephone; the charging port comprises a USB port and a charging cable; an electrical device is connected to the charging apparatus through a corresponding charging port.

2. The charging apparatus according to claim 1, wherein the electrical device is connected to the USB port through a converter cable adapting to a charging port of the electrical device and the USB port; and the USB port comprises an A type USB female port.

3. The charging apparatus according to claim 1, wherein at least a Mini USB port, a Micro USB port, an Apple lighting port and an Apple Docking port are provided on the charging cable to directly connect the charging cable with different electrical devices.

4. The charging apparatus according to claim 1, wherein the base is connected to the telephone through a buckle and a slot; or through a screw.

5. The charging apparatus according to claim 1, wherein the power supply comprises a direct current outputted by an alternating current to direct current power adapter and/or a direct current outputted by active Ethernet PoE.

6. The charging apparatus according to claim 2, wherein at least a Mini USB port, a Micro USB port, an Apple lighting port and an Apple Docking port are provided on the charging cable to directly connect the charging cable with different electrical devices.
